(19) United States
(12) Patent Application Publication
(10) Pub. No.: US 2026/0001073 A1
(43) Pub. Date: Jan. 1, 2026

(54) Sampling device

(71) Applicant: BiopSense Oy, Jyväskylä (FI)

(72) Inventors: Petri Kallberg, Jyväskylä (FI); Veli-Mikko Puupponen, Jyväskylä (FI)

(21) Appl. No.: 19/252,085

(22) Filed: Jun. 27, 2025

(30) Foreign Application Priority Data
Jun. 28, 2024 (FI) 20245833

(51) Int. Cl. B01L 3/00

(52) U.S. Cl. CPC B01L 3/502715; B01L 2200/18; B01L 2300/044; B01L 2300/0672; B01L 2300/0832

(57) ABSTRACT

According to an example aspect, there is provided a sampling device for transferring a fluidic sample from a sampling container comprising a closed lid, the sampling device comprising: a receptacle body extending along an axis, a first needle and a second needle arranged at least partially inside the receptacle body and extending along the axis, which second needle is arranged coaxially with the first needle and partially inside the first needle, and a needle tip support arranged inside the receptacle body for supporting a tip of the second needle, which needle tip support is configured to open or retract, when a force in a direction of the axis is applied to the tip of the second needle.

### FIELD

The present invention relates to sampling devices. Particularly, the present invention relates to a sampling device for transporting a fluidic sample from a sampling container comprising a closed lid.

### BACKGROUND

Blood samples are commonly collected into blood collection tubes (BCT). The BCT is a type of a sampling container most commonly in the shape of a test tube having a sealing element, i.e. a septum, which can be penetrated with a sharp element, e.g. a needle, to transfer material from and into the BCT. Most commonly BCTs are supplied from the factory with a prefilled vacuum enabling e.g. venous blood to be drawn into the container with a simple double-ended needle without the aid of additional tools. As air molecules readily move through plastics and elastomers by diffusion, thus constantly reducing the quality of the vacuum inside the container, the BCTs are made of a relatively thick polycarbonate or glass shell, having a thick 5-8 mm septum made of butyl rubber.

After a blood sample has been drawn into the BCT, it is most often retrieved from the BCT by removing the cap by pulling it up either manually or by an automatic instrument designed for this purpose. Threaded caps are seldom used. One drawback of this approach is that it can release pathogens from the blood into the air, thus necessitating biosafety working areas and other suitable laboratory practices to prevent disease transfer and worker pathogen exposure. Another risk involved is the spilling of the sample material.

By not removing the cap from the BCT, it is possible to achieve a more streamlined process and reduce the associated risks. However, to be able to retrieve the complete sample volume from the closed BCT, it is necessary to be able to access both material phases within the BCT: a liquid phase from the bottom of the BCT and a gas phase above the liquid. If the access takes place from another position, e.g. closer to the center of the BCT, it is not possible to withdraw the complete sample, and the incoming replacement air creates persistent bubbles into the sample when introduced within the liquid phase. Therefore, it is advantageous to have a configuration where access can be simultaneously gained to the very bottom and to the very top part of the space inside the BCT.

As the BCTs have an elongated shape, it has been recognized that it is necessary to have a relatively long, about >100 mm, needle to be able to access the bottom of the container. This needle will either be used to retrieve the blood or to supply the replacement air into the tube depending on whether the tube is in its natural or inverted position respectively. However, it is advantageous for the needles to interface with the septum of the BCT in the very middle area, or the needle can be heavily bent when the insertion point is off-axis and the BCT is inserted all the way into the sampling device. This necessitates an efficient solution for centering the needle tip during the insertion process of the BCT. Another potential consideration is the prevention of the bending of the needle from the insertion force and friction: if the wall thickness of the needle is of a regular gauge, it is potentially not rigid enough to withstand the insertion force of the BCT without “bowing” towards the outer edge of the sample tube receptacle. This in turn leads to similar problems as does the needle tip de-centering and can potentially destroy the needle, rendering the sampling device unusable.

One obvious approach to reduce these problems is to make the needles stronger by manufacturing them of thicker material, i.e. with larger diameter and/or thicker wall and smaller inner bore. However, in the first case the insertion force will heavily increase, as the needle surface friction is higher for the larger outer diameter. It is also often useful to employ needles with a blunt or square tip to not cut pieces off the septum material. Such coring debris could block the needle bore and render the sampling device inoperable, but this type of tip further increases insertion force for larger needle diameters. If the needle outer diameter is kept constant while the bore diameter is reduced to improve the needle strength, material flow can be significantly impeded. Even another limitation for the use of thicker needles is that while this can with suitable design parameters effectively prevent needle deformation or bowing action during the sample tube insertion, it is still necessary to have a solution for keeping the needle tip in the middle of the sample tube receptacle.

An object of the present invention is to mitigate at least some of the above-mentioned problems. Thus, the object of the present invention is to provide a sampling device having a needle, which is easy to center and is rigid enough to withstand the insertion force of the BCT without bowing.

### SUMMARY

According to a first aspect of the present disclosure, there is provided a sampling device for transferring a fluidic sample from a sampling container comprising a closed lid, the sampling device comprising:
a receptacle body extending along an axis,
a first needle and a second needle arranged at least partially inside the receptacle body and extending along the axis, which second needle is arranged coaxially with the first needle and partially inside the first needle, and
a needle tip support arranged inside the receptacle body for supporting a tip of the second needle, which needle tip support is configured to open or retract, when a force in a direction of the axis is applied to the tip of the second needle.

Significant benefits are gained with aid of the present sampling device. It provides an efficient solution for centering the needle tip during the insertion of the BCT into the sampling device. In addition, it prevents the needle from bending due to the insertion force and friction. As the BCTs have an elongated shape, it has been recognized that it is necessary to have a relatively long, about >100 mm, needle to be able to access the bottom of the container. Therefore, it is necessary to support the tip of the second needle to prevent it from interfacing off-axis with the sampling container lid, because supporting only at the end of the second needle is not enough to compensate for common manufacturing and assembly tolerances leading to off-axis position of the tip for long needles. The efficient support is achieved by the present needle tip support. In addition, the needle tip support allows the elongated sampling container to penetrate into the receptable body, so that the first needle and the second needle reach a content of the sampling container and a sample can be taken from the sampling container.

One or more embodiments may comprise one or more features from the following itemized list:
the needle tip support is configured to allow the sampling container pass through the needle tip support, when the sampling container is inserted into the receptacle body, when the needle tip support is configured to open
the needle tip support is configured to retract inside the receptacle body, when the sampling container is inserted into the receptacle body, when the needle tip support is configured to retract
the needle tip support is configured to detach at least partially from an outer surface of the tip of the second needle, when the second needle penetrates the lid of the sampling container, when the needle tip support is configured to open
the needle tip support is configured to move along the second needle towards an end of the second needle, when the needle tip support is configured to retract
the needle tip support is arranged at a distance from the tip of the second needle
the distance is 0 to 10% of the length of the second needle
the sampling device further comprises a needle middle support inside the receptacle body for supporting the second needle between the tip and an end of the second needle
the needle middle support is arranged at a distance from the tip of the second needle
the distance is 30 to 70% of the length of the second needle
the needle tip support is a wing-type support comprising two or more flaps
the flaps are in contact with an outer surface of the tip of the second needle
the flaps are configured to move apart from the tip
the needle tip support is a disk-shaped support extending in a plane extending orthogonally to the axis
the needle tip support is a spring support, wherein the second needle is arranged inside the spring support
the needle middle support is a disk-shaped support extending in a plane extending orthogonally in respect to the axis
the needle middle support is a spring support, wherein the second needle is arranged inside the spring support
the flaps of the wing-type support have a curvature enabling at least part of them to retain at least partial contact with the second needle during their opening, when the force in the direction of the axis is applied to the tip of the second needle
the wing-type support comprises one or more than one pre-perforated area or line
the flaps are configured to break of from each other during insertion of the second needle between the flaps
a material of the wing-type support is selected from a group consisting of polymers, such as polypropylene or polyethylene, paper-based materials, composite materials, such as wood-polymer-composite, and mixtures thereof
the disk-shaped support is a circular disk-shaped support
the second needle extends through the disk-shaped support
the disk-shaped support has a preformed hole for receiving the second needle though the disk-shaped support
a material of the disk-shaped support is selected from synthetic foams, for example polymer foams, such as polyether, polyester, polyurethane or polyethylene foam, or natural fibers
the disk-shaped support has a material thickness of 5-12 mm in the dimension of the axis
a nominal outer diameter of the disk-shaped support is 1-30%, such as 10-18%, larger than a nominal inner diameter of the sampling container
the spring support has a first portion, a second portion and a third portion successively along the axis
the first portion is closer to the tip of the second needle than the second portion and the third portion
the first portion has more tight windings than the second portion and/or the third portion
the first portion has a circular or rectangular profile, the second portion has a rectangular profile and/or the third portion has a circular profile when viewed in the direction of the axis
the second needle is longer than the first needle
the length of the second needle is 2-8 times the length of the first needle
the first needle has a nominal inner diameter of 1.0-2.4 mm
the first needle has a nominal outer diameter of 1.5-3.0 mm
the second needle has a nominal inner diameter of 0.5-1.4 mm
the second needle has a nominal outer diameter of 0.8-1.8 mm

According to a second aspect of the present disclosure, there is provided use of the sampling device for transferring a fluidic sample from a sampling container comprising a closed lid.

### BRIEF DESCRIPTION OF THE DRAWINGS

FIG. 1 illustrates a sampling device having a wing-type support as a needle tip support and a disk-shaped support as a needle middle support in accordance with at least some embodiments;

FIG. 2 illustrates a sampling device having a disk-shaped support as a needle tip support and a disk-shaped support as a needle middle support in accordance with at least some embodiments;

FIG. 3 illustrates a sampling device having a spring support as a needle tip support and a disk-shaped support as a needle middle support in accordance with at least some embodiments;

FIG. 4 illustrates a sampling device having spring supports as a needle tip support and as a needle middle support in accordance with at least some embodiments;

FIG. 5A illustrates a wing-type support in an initial position before contact with a sampling container in accordance with at least some embodiments;

FIG. 5B illustrates the wing-type support when a tip of a second needle touches a closed lid of the sampling container in accordance with at least some embodiments;

FIG. 5C illustrates the wing-type support when the second needle penetrates the closed lid of the sampling container in accordance with at least some embodiments;

FIG. 5D illustrates the wing-type support when a blood sample is collected from the sampling container in accordance with at least some embodiments;

FIG. 6A illustrates the wing-type support of FIG. 5A with a sampling container in accordance with at least some embodiments;

FIG. 6B illustrates the wing-type support of FIG. 5B with the sampling container in accordance with at least some embodiments;

FIG. 6C illustrates the wing-type support of FIG. 5C with the sampling container in accordance with at least some embodiments;

FIG. 6D illustrates the wing-type support of FIG. 5D with the sampling container in accordance with at least some embodiments;

FIG. 7 illustrates a wing-type support having a pre-perforated area in accordance with at least some embodiments; and

FIG. 8 illustrates a spring support having a first portion, a second portion and a third portion in accordance with at least some embodiments.

### EMBODIMENTS

In the present context, the term “a sampling container” refers to a container, such as a blood collection tube (BCT), for collecting a sample, such as a blood sample.

In the present context, the term “a closed lid” refers to a sealing element, such as a septum.

In the present context, the term “a tip of a second needle” refers to an end of the second needle, which is configured to penetrate a closed lid of a sampling container.

In the present context, the term “an end of a second needle” refers to an end of the second needle, which is opposite than the tip in a dimension of an axis X.

In the present context, the term “an outer surface of a second needle” refers to a surface of the second needle, which is facing a receptable body and/or a first needle.

In the present context, the term “an inner surface of a receptable body” refers to a surface of the receptable body, which encloses at least partially the first needle and the second needle.

In the present context, the term “an outer surface of a sampling container” refers to a surface of the sampling container, which surface is not intended to be in contact with a sample and is configured to at least partially face the inner surface of the receptable body, when the sampling container is inserted inside the receptable body.

In the present context, the term “a nominal outer diameter of a disk-shaped support” refers to an outer diameter of the disk-shaped support before the disk-shaped support is inserted inside the receptable body. By “the outer diameter”, it is meant a diameter of a material of the disk-shaped support in a dimension, which is perpendicular to the axis X.

According to a first aspect, there is provided a sampling device 100 for transferring a fluidic sample from a sampling container 200 comprising a closed lid 210, the sampling device 100 comprising:
a receptacle body 110 extending along an axis X,
a first needle 111 and a second needle 112 arranged at least partially inside the receptacle body 110 and extending along the axis X, which second needle 112 is arranged coaxially with the first needle 111 and partially inside the first needle 111, and
a needle tip support 120, 130, 140 arranged inside the receptacle body 110 for supporting a tip 113 of the second needle 112, which needle tip support 120, 130, 140 is configured to open or retract, when a force in a direction of the axis X is applied to the tip 113 of the second needle 112.

Significant benefits are gained with aid of the present sampling device 100. It provides an efficient solution for centering the needle tip 113 of the second needle 112 during the insertion of the blood collection tube (BCT) into the sampling device 100. In addition, it prevents the second needle 112 from bending due to the insertion force and friction. As the BCTs have an elongated shape, it has been recognized that it is necessary to have a relatively long, about >100 mm, needle to be able to access the bottom of the container. Therefore, it is necessary to support the tip 113 of the second needle 112 to prevent it from interfacing off-axis with the sampling container lid, because supporting only at the end 114 of the second needle 112 is not enough to compensate for common manufacturing and assembly tolerances leading to off-axis position of the tip for long needles. The efficient support is achieved by the present needle tip support 120, 130, 140. In addition, the needle tip support 120, 130, 140 allows the elongated sampling container 200 to penetrate into the receptable body 110, so that the first needle 111 and the second needle 112 reach a content of the sampling container 200 and a sample can be taken from the sampling container 200.

During the operation of the sampling device 200, sample flows through the second needle 112. On the same axis as the second needle 112, the first needle 111 is used to supply replacement gas. This coaxial arrangement of the needles allows for easy positioning and installation of the needles into the receptable body when compared to a side-by-side configuration of two needles. If the two needles were to be used in a side-by-side configuration, a complex needle mounting system would be necessary when manufacturing the receptable body. This would involve custom machinery for gluing the needles and for inspection of the resulting joint. For two needles within each other, it is possible to use commonly available needle hub design and stack them inside the receptable body. The present approach supports straightforward commercial off-the-shelf part sourcing.

The needle tip support 120, 130, 140 can be configured to:
allow the sampling container 200 pass through the needle tip support 120, when the sampling container 200 is inserted into the receptacle body 110, when the needle tip support 120 is configured to open, or
retract inside the receptacle body 110, when the sampling container 200 is inserted into the receptacle body 110, when the needle tip support 130, 140 is configured to retract.

When the needle tip support 120 is configured to open or when the needle tip support 130, 140 is configured to retract inside the receptable body 110, it allows the sampling container 200 to penetrate into the receptable body 110, so that the first needle 111 and the second needle 112 reach a content of the sampling container and a sample can be taken from the sampling container. The needle tip support 130, 140 can be configured to retract inside the receptable body 110 along the axis X.

The needle tip support 120, 130, 140 can be configured to:
detach at least partially from an outer surface of the tip 113 of the second needle 112, when the second needle 112 penetrates the lid 210 of the sampling container 200, when the needle tip support 120 is configured to open, or
move along the second needle 112 towards an end of the second needle 112, when the needle tip support 130, 140 is configured to retract.

For example, the needle tip support 120 configured to open can be hingedly connected to the receptable body 110 so that it can detach from the outer surface of the tip 113 of the second needle 112. For example, the needle tip support 130, 140 configured to retract can have a density and surface properties which allow the needle tip support 130, 140 to slide inside the receptable body 110. The needle tip support 130, 140 configured to retract can be arranged to move along the second needle 112 along the axis X.

The needle tip support 120, 130, 140 can be arranged at a distance from the tip 113 of the second needle 112, which distance is 0 to 10%, such as 5 to 10%, of the length of the second needle 112. The distance is measured as the shortest distance between the needle tip support 120, 130, 140 and the tip 113 of the second needle 112, i.e. a distance between a surface of the needle tip support 120, 130, 140 facing the tip 113 and the tip 113.

The sampling device 100 can further comprise a needle middle support 150, 160 inside the receptacle body 110 for supporting the second needle 112 between the tip 113 and the end 114 of the second needle 112. The needle middle support 150, 160, together with the needle tip support 120, 130, 140, prevents the second needle 112 from bending due to the insertion force and friction during penetration of the second needle 112 into the closed lid 210, i.e. when the force in the direction of the axis X is applied to the tip 113 of the second needle 112.

The needle middle support 150, 160 can be configured to retract inside the receptacle body 110, when the sampling container 200 is inserted inside the receptacle body 110. For example, the needle middle support 150, 160 configured to retract can have a density and surface properties which allow the needle middle support 150, 160 to slide inside the receptable body 110. The needle middle support 150, 160 can be configured to retract inside the receptable body 110 along the axis X.

The needle middle support 150, 160 can be configured to move along the second needle 112 towards an end of the second needle 112. The needle middle support 150, 160 configured to retract can be arranged to move along the second needle 112 along the axis X.

The needle middle support 150, 160 can be arranged at a distance from the tip 113 of the second needle 112, which distance is 30 to 70% of the length of the second needle 112. The distance is measured as the shortest distance between the needle middle support 150, 160 and the tip 113 of the second needle 112, i.e. a distance between a surface of needle middle support 150, 160 facing the tip 113 and the tip 113.

The needle tip support 120, 130, 140 can be:
a wing-type support 120 comprising two or more flaps 121, which are in contact with an outer surface of the tip 113 of the second needle 112 and configured to move apart from the tip (113),
a disk-shaped support 130 extending in a plane extending orthogonally to the axis X, or
a spring support 140, wherein the second needle 112 is arranged inside the spring support 140.

The needle middle support 150, 160 can be:
a disk-shaped support 150 extending in a plane extending orthogonally in respect to the axis X, or
a spring support 160, wherein the second needle 112 is arranged inside the spring support 160.

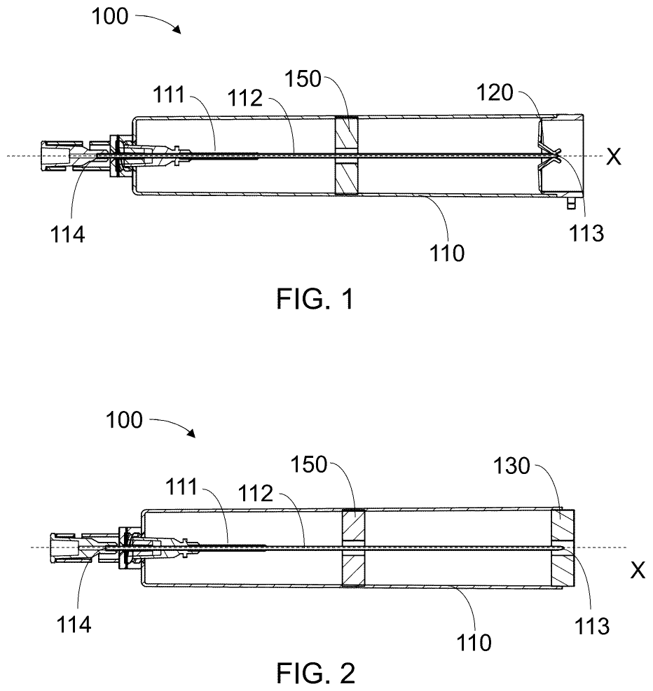

FIG. 1 illustrates a sampling device 100 having a wing-type support 120 as a needle tip support and a disk-shaped support 150 as a needle middle support. The wing-type support 120 and the disk-shaped support 150 are arranged inside a receptable body 110, which extends along an axis X. Two needles, i.e. a first needle 111 and a second needle 112, are arranged inside the receptable body 110 and extending along the axis X. The second needle 112 is arranged coaxially with the first needle 111 and partially inside the first needle 111. The second needle 112 has a tip 113 and an opposite end 114 in a direction of the axis X. The wing-type support 120 is arranged near the tip 113 of the second needle 112 and the disk-shaped support 150 is arranged between the tip 113 and the end 114 of the second needle 112. The wing-type support 120 and the disk-shaped support 150 support the second needle 112.

FIG. 2 illustrates a sampling device 100 having a disk-shaped support 130 as a needle tip support and a disk-shaped support 150 as a needle middle support. The disk-shaped supports 130, 150 are arranged inside a receptable body 110, which extends along an axis X. Two needles, i.e. a first needle 111 and a second needle 112, are arranged inside the receptable body 110 and extending along the axis X. The second needle 112 is arranged coaxially with the first needle 111 and partially inside the first needle 111. The second needle 112 has a tip 113 and an opposite end 114 in a direction of the axis X. The disk-shaped supports 130, 150 are arranged near the tip 113 of the second needle 112 and between the tip 113 and the end 114 of the second needle 112. The disk-shaped supports 130, 150 support the second needle 112.

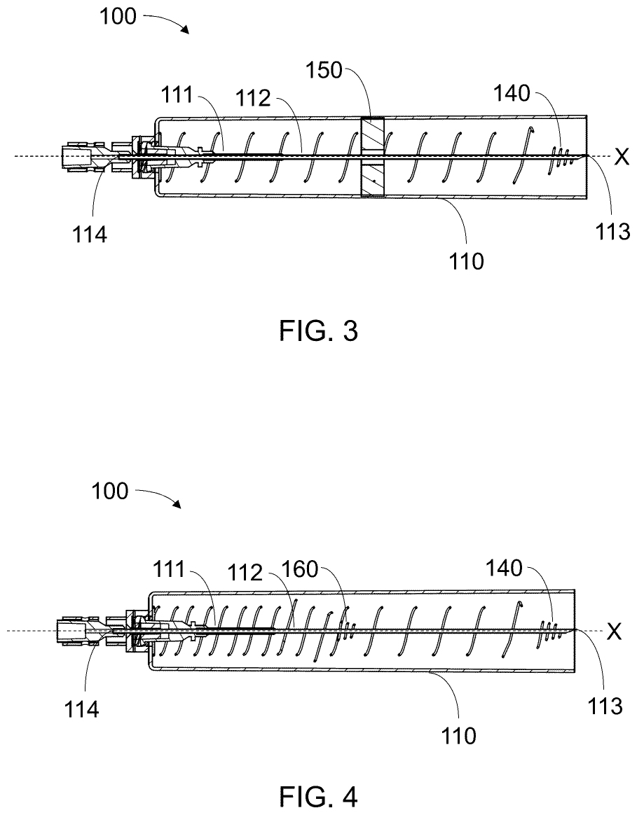

FIG. 3 illustrates a sampling device 100 having a spring support 140 as a needle tip support and a disk-shaped support 150 as a needle middle support. The spring support 140 and a disk-shaped support 150 are arranged inside a receptable body 110, which extends along an axis X. Two needles, i.e. a first needle 111 and a second needle 112, are arranged inside the receptable body 110 and extending along the axis X. The second needle 112 is arranged coaxially with the first needle 111 and partially inside the first needle 111. The second needle 112 has a tip 113 and an opposite end 114 in a direction of the axis X. The first needle 111 and the second needle 112 are arranged inside the spring support 140. The spring support 140 extends from the tip 113 of the second needle 112 towards the end 114 of the second needle 112. The spring support 140 extends throughout an inner length of the receptable body 110. The spring support 140 has more tight windings around the tip 113 of the second needle 112 than around the rest of the length of the second needle 112. The disk-shaped support 150 is arranged between the tip 113 and the end 114 of the second needle 112. The spring support 140 and the disk-shaped support 150 support the second needle 112.

FIG. 4 illustrates a sampling device 100 having spring supports 140, 160 as a needle tip support and a needle middle support. The spring supports 140, 160 are arranged inside a receptable body 110, which extends along an axis X. Two needles, i.e. a first needle 111 and a second needle 112, are arranged inside the receptable body 110 and extending along the axis X. The second needle 112 is arranged coaxially with the first needle 111 and partially inside the first needle 111. The second needle 112 has a tip 113 and an opposite end 114 in a direction of the axis X. The first needle 111 and the second needle 112 are arranged inside the spring supports 140, 160. The second needle 112 has a first portion and a second portion, which first portion is closer to the tip 113 of the second needle 112 than the second portion in the direction of the axis X. The spring support 140 being the needle tip support is around the first portion and the spring support 160 being the needle middle support is around the second portion. The spring support 140 being the needle tip support extends from the tip 113 of the second needle 112 towards the end 114 of the second needle 112. The spring support 160 being the needle middle support extends from the middle of the second needle 112 towards the end 114 of the second needle 112. Portions of the spring supports 140, 160 being closer the tip 113 of the second needle 112 have more tight windings than the rest of the lengths of the spring supports 140, 160. The spring supports 140, 160 support the second needle 112.

The wing-type support 120 can comprise two or more flaps 121. Each flap 121 of the wing-type support 120 can have a curvature enabling at least part of them to retain at least partial contact with the second needle 112 during their opening, when the force in the direction of the axis X is applied to the tip 113 of the second needle 112, particularly during insertion of the sampling container 200 into the receptacle body 110. In an initial position, the flaps 121 can extend towards the central part of the receptacle body 110 forming a passage around the X axis. The flaps 121 can have a curvature that provides support to the second needle 112 in the direction of the X-axis prior to the sampling container 200 being inserted in the receptacle body 110. Upon insertion of the sampling container 200, the flaps 121 are pushed away from the tip 113 of the second needle 112 towards the inner wall of the receptacle body 110. So, the wing-type support 120 can deform in a way that allows the sampling container 200 to pass through the wing-type support. At the same time, a part of a geometry of the wing-type support 120 has been designed in such a way that the flaps 121 keep in partial contact with an outer wall of the second needle as long as possible, thus supporting the second needle from decentering or bowing during the sampling container 200 insertion. Optimally after the tip 113 of the second needle 112 firmly touches an external surface of the closed lid 210 of the sampling container 200, the flaps 121 of the wing-type support 120 releases from the outer surface of the second needle 112.

Each flap 121 can comprise one or more, such as two or three, joints. For example, each flap 121 can be mounted hingedly on the inner surface of the receptable body 110, thereby forming a first joint between the flap 121 and the receptable body 110. Each flap 121 can comprise two or more portions. Then, each flap 121 can comprise joints between the portions, thereby forming further joints into the flaps 121. Alternatively, or in addition, each flap 121 can be made of elastic or flexible material, such as polypropylene, which allows the flaps 121 to bend upon insertion of the sampling container 200.

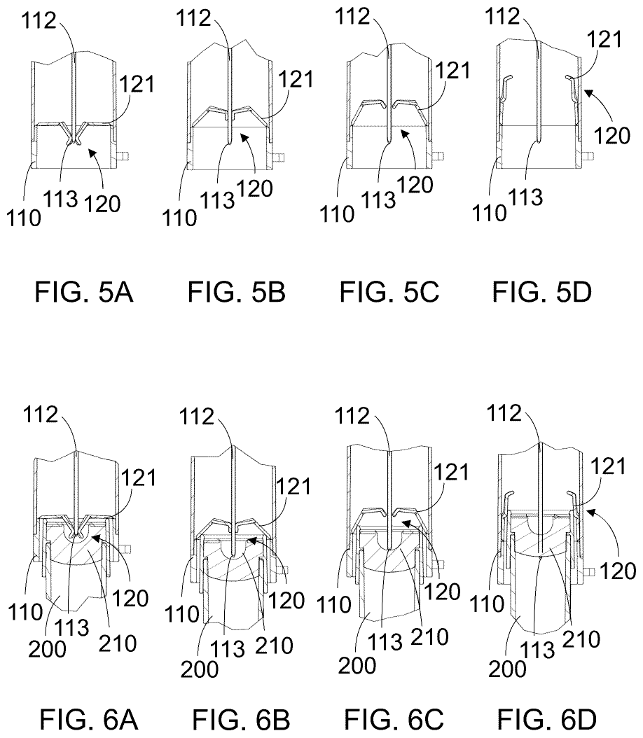

In the following, a structure and a function of the wing-type support 120 according to some embodiments is explained referring to FIGS. 5A-5D and FIGS. 6A-6D.

FIG. 5A illustrates a wing-type support 120 in an initial position before contact of a second needle 112 with a closed lid of a sampling container. The wing-type support 120 has two flaps 121, which are in contact with an outer surface of the second needle 112, a tip 113 of the second needle 112 being between the flaps 121. Thus, the flaps 121 support the tip 113. The wing-type support 120 is mounted hingedly on an inner surface of a receptable body 110.

FIG. 5B illustrates the wing-type support 120 when the tip 113 of the second needle 112 touches the closed lid of the sampling container. The flaps 121 are still in contact with the outer surface of the second needle 112 and support the second needle 112 at a distance from the tip 113 of the second needle 112. The flaps 121 have been moved towards inner surface of the receptable body 110.

FIG. 5C illustrates the wing-type support 120 when the second needle 112 penetrates the closed lid of the sampling container. The flaps 121 are still in a partial contact with the outer surface of the second needle 112 and support the second needle 112 at a distance from the tip 113 of the second needle 112. The flaps 121 have been moved further towards inner surface of the receptable body 110.

FIG. 5D illustrates the wing-type support 120 when a sample is collected from the sampling container. The flaps 121 are detached from the outer surface of the second needle 112 and have been moved even further towards inner surface of the receptable body 110.

FIG. 6A illustrates the wing-type support 120 of FIG. 5A with a sampling container 200. The sampling container 200 is partially inside the receptable body 110 so that the lid 210 of the sampling container does not touch the tip 113 of the second needle.

FIG. 6B illustrates the wing-type support 120 of FIG. 5B with the sampling container 200. The sampling container 200 is partially inside the receptable body 110 so that the second needle 112 touches the closed lid 210 of the sampling container 200.

FIG. 6C illustrates the wing-type support 120 of FIG. 5C with the sampling container 200. The sampling container 200 is partially inside the receptable body 110 so that the second needle 112 penetrates the closed lid 210 of the sampling container 200.

FIG. 6D illustrates the wing-type support 120 of FIG. 5D with the sampling container 200. The sampling container 200 is partially inside the receptable body 110 and between the flaps 121 of the wing-type support 120. The second needle 112 is inserted through the closed lid 210. The sampling container 200 can be moved further into the receptable body 110 so that also the first needle reaches the sampling container 200 and then the second needle 112 can be used to collect a sample from the sampling container 200.

The wing-type support 120 can comprise one or more than one pre-perforated area or line 122, where the flaps 121 are configured to break of from each other during insertion of the second needle 112 between the flaps 121. The pre-perforated area(s) or line(s) 112 allow(s) the structure to retain an initial position and to center the second needle even when subjected to for example, a significant shock perpendicular to the axis X. This is an advantageous feature for example, during device transportation.

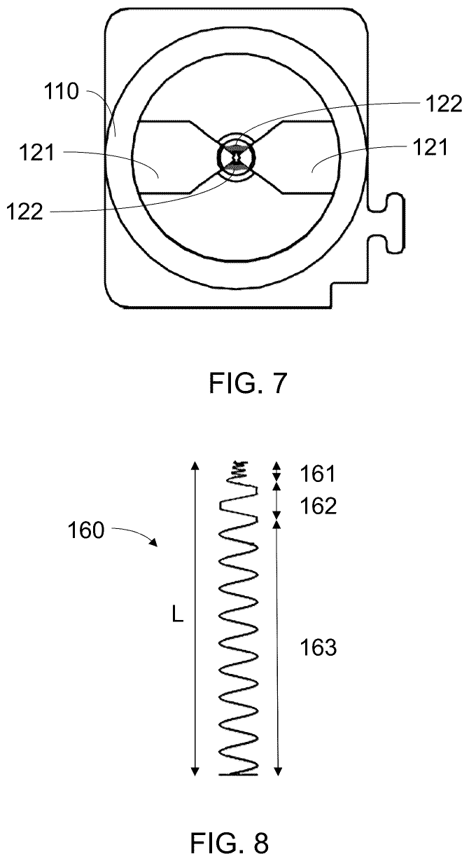

FIG. 7 illustrates a wing-type support 120 having pre-perforated areas 122. The wing-type support 120 is placed inside a receptable body 110 and has two flaps 121, which are contact with each other. The flaps 121 are connected to each other with two pre-perforated areas 122, which extend perpendicularly to the dimension of the axis X.

A material of the wing-type support 120 can be selected from a group consisting of polymers, such as polypropylene or polyethylene, paper-based materials, composite materials, such as wood-polymer-composite, and mixtures thereof. So, the wing-type support 120 can be made from the same material as the receptable body 110, for example, from polypropylene or polyethylene, and therefore fabricated even simultaneously without additional tooling, assembly or processing steps.

When the disk-shaped support 130, 150 is used, the second needle 112 can extend through the disk-shaped support(s) 130, 150.

The disk-shaped support 130, 150 can have a circular cross-section when viewed along the axis X, i.e. the disk-shaped support 130, 150 can be a circular disk-shaped support. Thus, a cross-sectional shape of the disk-shaped support 130, 150 corresponds an inner cross-sectional shape of the receptacle body 100 and the disk-shaped support 130, 150 can easily slide inside the receptacle body 110.

The disk-shaped support 130, 150 can have a preformed hole for receiving the second needle 112 though the disk-shaped support 130, 150. The preformed hole facilitates insertion of the second needle 112 though the disk-shaped support 130, 150.

As the second needle 112 is sharp and able to penetrate the disk-shaped supports 130, 150 at any point on the surface, maybe even regardless of any preformed holes, it may need to be already inside the receptacle body 110 when the disk-shaped supports 130, 150 are inserted inside the receptable body 110. Therefore, the sampling device 100 may further comprise a guiding mechanism, to ensure that the second needle meets the disk-shaped supports 130, 150 in the center while still minimizing the handling of the second needle 112 to reduce contamination and the possible blunting of the needle tip 113.

A material of the disk-shaped support 130, 150 can be selected from synthetic foams, for example polymer foams, such as polyether, polyester, polyurethane or polyethylene foam, or natural fibre foam. Polyether foam can be medium-density polyether foam. The said materials are available in low densities and low enough frictions against the receptable body 110. It has been found that it is advantageous that the foam has a suitably low density to be able to collapse into a small volume to enable the sampling container 200 to be inserted all the way into the receptacle body 110. Another preferred feature is a low enough friction of the material against the inner wall of the receptacle body 110 so that the disk-shaped support 130, 150 can easily slide inside the receptacle body 110 without rolling and getting stuck between the inner wall of the receptable body 110 of an outer wall of the sampling container 200. The low enough friction also prevents the second needle 112 from bending and thus enhances centering of the second needle 112 during insertion of the sampling container 200 inside the receptable body 110.

The disk-shaped support 130, 150 can have a material thickness of 5-12 mm in the direction of the axis X.

A nominal outer diameter of the disk-shaped support 130, 150 can be 1-30%, such as 10-18%, larger than a nominal inner diameter of the sampling container 200. It has been found that this provides sufficient but a low enough friction so that the disk-shaped support 130, 150 can stay at a preferred position inside the receptable body 110 after the insertion, but the friction between the disk-shaped support 130, 150 and the respectable body 110 is a low enough so that the disk-shaped support 130, 150 can easily slide inside the receptacle body 110, when the sampling container 200 is inserted inside the receptable body 110.

When the spring support 140, 160 is used, the spring support 140, 160 can have a first portion 161, a second portion 162 and a third portion successively along the axis X, which first portion 161 is closer to the tip 113 of the second needle 112 than the second portion 162 and the third portion 163. The first portion 161 can have more tight windings than the second portion 162 and/or the third portion 163. The tight windings at the first portion 161 provides a tight interface with the second needle 112 and sufficient centering action, while allowing the first needle 111 to pass through the spring support 140, 160 unrestricted.

The first portion 161 can have an inner maximal diameter of 120% to 150% relative to a nominal outer diameter of the first needle 111, and a length of 0.5% to 5% relative to the overall length L of the spring support 140, 160. The first portion 161 of the spring support 140, 160 can have a circular or rectangular profile when viewed in the direction of the axis X. Ease of manufacturing can be the selection criteria for the profile of the first portion, but the rectangular profile has a smaller contact surface area with the first needle 111 and is therefore preferred.

The second portion 162 can have an outer maximal diagonal size of 90% to 105% of an internal diameter of the receptacle body 100, and a length of 5% to 15% relative to the overall length L of the spring support 140, 160. The second portion 162 of the spring support 140, 160 can have a rectangular profile when viewed in the direction of the axis X.

The third portion 163 can have an external diameter of 70% to 90% of the internal diameter of the receptacle body 110, and a length of 65% to 85% of the overall length L of the spring support 140, 160. The third portion 163 of the spring support 140, 160 can have a circular profile when viewed in the direction of the axis X.

The spring support 140, 160 can be manufactured of steel.

FIG. 8 illustrates a spring support 160 having a first portion 161, a second portion 162 and a third portion 163. The spring support 160 has a length L. The first portion 161 has more tight windings than the second portion 162 and the third portion 163. A length of the third portion is greater than a length of the first portion 161 and the second portion 162. The first portion 161 has a circular profile, the second portion 162 has a rectangular profile and the third portion 163 has a circular profile when viewed in the direction of the axis X.

The second needle 112 can be longer than the first needle 111. For example, the length of the second needle 112 can be 2-8 times the length of the first needle 111. For example, the second needle 112 can have a length of 124 mm and the first needle can have a length of 18 mm. However, depending on a length of the receptable body 110 and a type of the sampling container 200, the lengths of the needles 111, 112 may vary.

Typically, needle sizes are presented as Birmingham Gauge (G) values, which defines both internal and external diameters, but there are variations to the wall thickness, so the internal diameter does not always adhere to the standard value. For the present coaxial configuration, where the second needle 112 fits inside the first needle 111, their gauge sizes can be at least four units apar. It is advantageous to have a large enough internal diameter to transfer blood from the sampling container 200 without significant backpressure, but also to have such second needle 112 diameter that it penetrates the septum without excessive force.

Therefore, the first needle 111 can be in the range of 17G to 11G, i.e. have a nominal inner diameter of 1.0-2.4 mm and a nominal outer diameter of 1.5-3.0 mm, and the second needle 112 can be in the range of 21G to 15G, i.e. have a nominal inner diameter of 0.5-1.4 mm and a nominal outer diameter of 0.8-1.8 mm.

According to an aspect, there is provided use of the sampling device 100 for transferring a fluidic sample from a sampling container 200 comprising a closed lid 210.

The sampling container 200 can be a collection tube, such as a blood collection tube (BCT).

The receptacle body 110 can have a circular inner cross-section when viewed along the axis X.

The closed lid 210 can be a septum of the BCT.

The fluidic sample can be for example, a blood sample, a urine sample, a pleural fluid sample, a cerebrospinal fluid sample or any other sample.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### REFERENCE SIGNS LIST

100 sampling device
110 receptacle body
111 first needle
112 second needle
113 tip
114 end
120 wing-type support
121 flap
122 pre-perforated area or line
130 disk-shaped support
140 spring support
150 disk-shaped support
160 spring support
161 first portion
162 second portion
163 third portion
200 sampling container
210 lid

1. A sampling device for transferring a fluidic sample from a sampling container comprising a closed lid, the sampling device comprising:
a receptacle body extending along an axis,
a first needle and a second needle arranged at least partially inside the receptacle body and extending along the axis, which second needle is arranged coaxially with the first needle and partially inside the first needle, and
a needle tip support arranged inside the receptacle body for supporting a tip of the second needle, which needle tip support is configured to open or retract, when a force in a direction of the axis is applied to the tip of the second needle.

2. The sampling device of claim 1, wherein the needle tip support is configured to:
allow the sampling container pass through the needle tip support, when the sampling container is inserted into the receptacle body, when the needle tip support is configured to open, or
retract inside the receptacle body, when the sampling container is inserted into the receptacle body, when the needle tip support is configured to retract.

3. The sampling device of claim 1, wherein the needle tip support is configured to:
detach at least partially from an outer surface of the tip of the second needle, when the second needle penetrates the lid of the sampling container, when the needle tip support is configured to open, or
move along the second needle towards an end of the second needle, when the needle tip support is configured to retract.

4. The sampling device of claim 1, wherein the needle tip support is arranged at a distance from the tip of the second needle, which distance is 0 to 10% of the length of the second needle.

5. The sampling device of claim 1, further comprising a needle middle support inside the receptacle body for supporting the second needle between the tip and an end of the second needle.

6. The sampling device of claim 5, wherein the needle middle support is arranged at a distance from the tip of the second needle, which distance is 30 to 70% of the length of the second needle.

7. The sampling device of claim 1, wherein the needle tip support is:
a wing-type support comprising two or more flaps, which are in contact with an outer surface of the tip of the second needle and configured to move apart from the tip,
a disk-shaped support extending in a plane extending orthogonally to the axis, or
a spring support, wherein the second needle is arranged inside the spring support.

8. The sampling device of claim 5, wherein the needle middle support is:
a disk-shaped support extending in a plane extending orthogonally in respect to the axis, or
a spring support, wherein the second needle is arranged inside the spring support.

9. The sampling device of claim 7, wherein the flaps of the wing-type support have a curvature enabling at least part of them to retain at least partial contact with the second needle during their opening, when the force in the direction of the axis is applied to the tip of the second needle.

10. The sampling device of claim 7, wherein the wing-type support comprises one or more than one pre-perforated area or line, where the flaps are configured to break of from each other during insertion of the second needle between the flaps.

11. The sampling device of claim 7, wherein a material of the wing-type support is selected from a group consisting of polymers, paper-based materials, composite materials, and mixtures thereof.

12. The sampling device of claim 7, wherein the second needle extends through the disk-shaped support.

13. The sampling device of claim 7, wherein the disk-shaped support has a preformed hole for receiving the second needle through the disk-shaped support.

14. The sampling device of claim 7, wherein a material of the disk-shaped support is selected from synthetic foams or natural fibers.

15. The sampling device of claim 7, wherein the disk-shaped support has a material thickness of 5-12 mm in the dimension of the axis.

16. The sampling device of claim 7, wherein a nominal outer diameter of the disk-shaped support is 1-30% larger than a nominal inner diameter of the sampling container.

17. The sampling device of claim 7, wherein the spring support has a first portion, a second portion and a third portion successively along the axis, which first portion is closer to the tip of the second needle than the second portion and the third portion, wherein the first portion has more tight windings than the second portion and/or the third portion.

18. The sampling device of claim 17, wherein the first portion has a circular or rectangular profile, the second portion has a rectangular profile and/or the third portion has a circular profile when viewed in the direction of the axis.

19. The sampling device of claim 1, wherein the second needle is longer than the first needle.

20. A method for transferring a fluidic sample, the method comprising utilizing the sampling device of claim 1 for transferring a fluidic sample from a sampling container comprising a closed lid.
